(19) United States
(12) Patent Application Publication
(10) Pub. No.: US 2025/0381825 A1
(43) Pub. Date: Dec. 18, 2025

(54) MOUNTING STRUCTURE FOR ACCUMULATOR

(71) Applicant: TOYOTA JIDOSHA KABUSHIKI KAISHA, Toyota-shi (JP)

(72) Inventor: Shoji OGIMURA, Toyota-shi (JP)

(73) Assignee: TOYOTA JIDOSHA KABUSHIKI KAISHA, Toyota-shi (JP)

(21) Appl. No.: 19/040,126

(22) Filed: Jan. 29, 2025

(30) Foreign Application Priority Data
Jun. 14, 2024 (JP) 2024-096717

(51) Int. Cl. B60H 1/32; F16M 13/02

(52) U.S. Cl. CPC B60H 1/3229; F16M 13/02

(57) ABSTRACT

A mounting structure for an accumulator includes an accumulator incorporated in an in-vehicle air conditioner and configured to separate a refrigerant mainly containing CO₂ into a gaseous refrigerant and a liquid refrigerant, and two or more brackets that mount the accumulator to a fixing member. The two or more brackets include an annular bracket that surrounds the accumulator in a circumferential direction, and an axial bracket. At least part of the shaft-side bracket is placed on and coupled to an axial end face of the accumulator.

### CROSS-REFERENCE TO RELATED APPLICATION

This application claims priority to Japanese Patent Application No. 2024-096717 filed on Jun. 14, 2024, incorporated herein by reference in its entirety.

### BACKGROUND

### 1. Technical Field

The present specification discloses mounting structure for accumulators provided in in-vehicle air conditioners.

### 2. Description of Related Art

An air conditioner typically generates conditioned air by transferring heat by compressing, expanding, evaporating, and condensing a refrigerant in the process of circulating the refrigerant. Many air conditioners include an accumulator that separates the refrigerant into a gaseous refrigerant and a liquid refrigerant.

Japanese Unexamined Patent Application Publication No. 2008-121926 (JP 2008-121926 A) discloses a refrigeration air conditioner including an accumulator. In JP 2008-121926 A, a refrigerant and polyalkylene glycol (PAG) oil are stored in the accumulator. In JP 2008-121926 A, the accumulator is provided with a heating device in order to reduce the possibility that the relationship between the density of the refrigerant and the density of the PAG oil may be reversed. With such a configuration, the refrigerant can be appropriately separated into a gaseous refrigerant and a liquid refrigerant.

Conventionally, fluorine-based refrigerants have been frequently used as air conditioning refrigerants. In recent years, however, it has been proposed to use CO₂ refrigerants mainly containing carbon dioxide (hereinafter referred to as “CO₂”) instead of the fluorine-based refrigerants in view of the environmental impacts. The CO₂ refrigerants have a significantly lower global warming potential than the fluorine-based refrigerants. JP 2008-121926 A uses a CO₂ refrigerant. However, the CO₂ refrigerants need to be pressurized to a higher pressure compared to the fluorine-based refrigerants.

### SUMMARY

It is herein assumed that a vehicle is equipped with an air-conditioner that uses a CO₂ refrigerant. In this case, there is a possibility that a strong impact may be applied to the air conditioner due to a collision etc. of the vehicle. If a pipe connected to an accumulator out of CO₂ refrigerant pipes is damaged at this time, the high-pressure CO₂ refrigerant is ejected from the accumulator. The accumulator may be moved forcefully due to the ejection pressure of the refrigerant.

In order to prevent or reduce such unintentional movement of the accumulator, it is necessary to sufficiently consider a mounting structure for an accumulator. However, JP 2008-121926 A does not sufficiently consider a mounting structure for an accumulator.

The present specification discloses a mounting structure for an accumulator that can prevent or reduce unintentional movement of an accumulator.

In one aspect, a mounting structure for an accumulator disclosed in the present specification includes:
an accumulator incorporated in an in-vehicle air conditioner, the accumulator being configured to separate a refrigerant mainly containing CO₂ into a gaseous refrigerant and a liquid refrigerant; and
two or more brackets that mount the accumulator to a fixing member.

The two or more brackets include
an annular bracket that surrounds the accumulator in a circumferential direction, and
a shaft-side bracket, at least part of the shaft-side bracket being placed on and coupled to an axial end face of the accumulator.

Two of the annular brackets may be provided spaced apart in an axial direction of the accumulator.

One end of the shaft-side bracket may be coupled to the axial end face of the accumulator, and another end of the shaft-side bracket may be integrally connected to the annular bracket.

In another aspect, a mounting structure for an accumulator includes:
an accumulator incorporated in an in-vehicle air conditioner, the accumulator being configured to separate a refrigerant mainly containing CO₂ into a gaseous refrigerant and a liquid refrigerant; and
one or more brackets that mount the accumulator to a fixing member.

The one or more brackets hold the accumulator so as to restrict movement of the accumulator due to gas ejection that occurs when the accumulator or a refrigerant pipe near the accumulator is damaged.

The one or more brackets may have a surface that faces the accumulator in a direction of the gas ejection.

With the mounting structure for the accumulator disclosed in the present specification, the bracket can receive a gas ejection pressure caused when the accumulator or the refrigerant pipe near the accumulator is damaged. Unintentional movement of the accumulator can thus be effectively prevented or reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of an air conditioner having an accumulator;

FIG. 2 is a perspective view of the accumulator periphery;

FIG. 3 is a side view of the accumulator periphery; and

FIG. 4 is an enlarged view of a main part of the lower bracket.

### DETAILED DESCRIPTION OF EMBODIMENTS

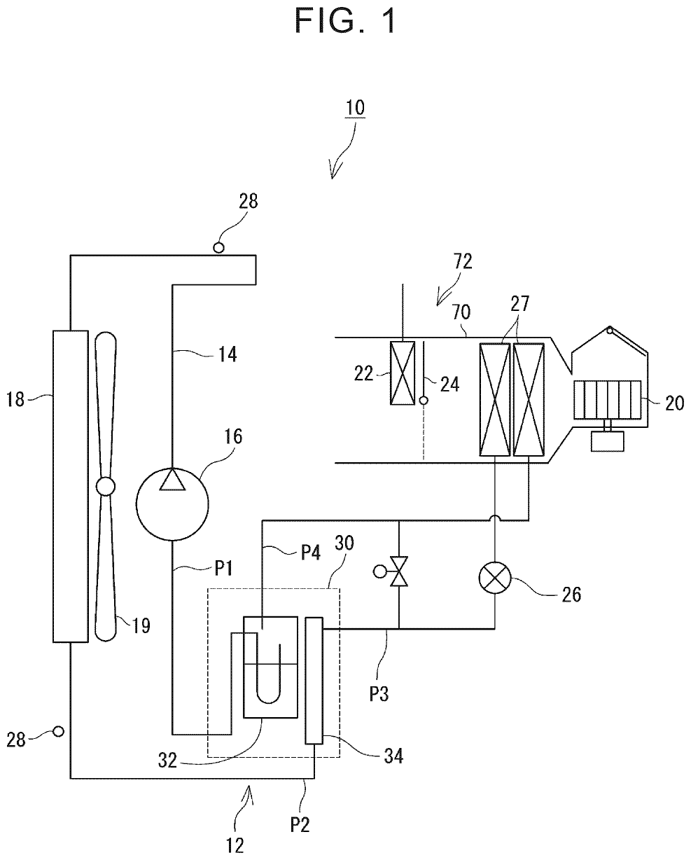

Hereinafter, a mounting structure of the accumulator 30 will be described with reference to the drawings. FIG. 1 is a diagram illustrating a configuration of an air conditioner 10 including an accumulator 30. The air conditioner 10 is mounted on a vehicle and adjusts the temperature of a vehicle cabin. The type of the vehicle on which the air conditioner 10 is mounted is not particularly limited. Therefore, the vehicle may be an engine vehicle using an engine as a power source or a battery electric vehicle using a motor as a power source. In addition, the vehicle may be a hybrid electric vehicle equipped with both an engine and a motor. In addition, the vehicle may be a fuel cell electric vehicle equipped with fuel cells. In addition, the vehicle may be a battery electric vehicle that runs on electric power stored in a battery.

The air conditioner 10 includes a refrigerant circuit 12. The refrigerant circuit 12 generates heat and latent heat by compressing, expanding, condensing, and evaporating the refrigerant in the process of circulating the refrigerant. Heat generated in the refrigerant circuit 12 is used for heating. The latent heat generated in the refrigerant circuit 12 is used for cooling. The circuit shown in FIG. 1 is used exclusively for cooling. Heating utilizes heat generated by another heat source (e.g., an engine, an electric heater, etc.).

Heretofore, a fluorine-based refrigerant has been frequently used as the refrigerant. However, there is a problem that the fluorine-based refrigerant has a high load on the environment. Therefore, a CO₂ refrigerant mainly containing CO₂ is used in this example. CO₂ refrigerants have lower global warming potential and lower environmental impact than fluorine-based refrigerants. On the other hand, CO₂ refrigerant needs to be used at a higher pressure than the fluorine-based refrigerant. For example, fluorine-based refrigerants are utilized in the range of 0.02 MPaG to 2 MPaG. In contrast, a CO₂ refrigerant is used in the range of 0.8 MPaG to 10 MPaG. Therefore, devices that handle CO₂ refrigerants are required to have high-voltage resistance.

The refrigerant circuit 12 includes a refrigerant pipe 14 through which CO₂ refrigerant flows. A compressor 16, a gas cooler 18, an accumulator 30, a cooling expansion valve 26, and an evaporator 27 are provided in the middle of the path of the refrigerant pipe 14. The compressor 16 compresses the gaseous CO₂ refrigerant. As described above, CO₂ refrigerant needs to be pressurized to a higher pressure than the fluorine-based refrigerant. In order to satisfy such pressure requirements, the compressor 16 is selected to have a large power and a large size.

The gas cooler 18 is a heat exchanger that exchanges heat between CO₂ refrigerant and the outside air. The gas cooler 18 functions as a condenser that condenses the gaseous CO₂ refrigerant during the cooling operation. A fan 19 for efficiently taking in outside air is disposed behind the gas cooler 18.

The accumulator 30 separates the CO₂ refrigerant into a gaseous refrigerant and a liquid refrigerant and sends only the gaseous CO₂ refrigerant to the compressor 16.

In addition, in the embodiment of FIG. 1, the accumulator 30 includes a body 32 that separates the CO₂ refrigerant into a gaseous refrigerant and a liquid refrigerant, and a heat exchanger 34 disposed around the body 32. CO₂ refrigerant after heat dissipation output from the gas cooler 18 is directed to the cooling expansion valve 26 through the heat exchanger 34. In the process of flowing through the heat exchanger 34, the CO₂ refrigerant after heat dissipation exchanges heat with a mixture of gaseous and liquid CO₂ refrigerants stored in the body 32. Heat dissipation from CO₂ refrigerant in the heat exchanger 34 to CO₂ refrigerant in the body 32 promotes vaporization of CO₂ refrigerant in the body 32.

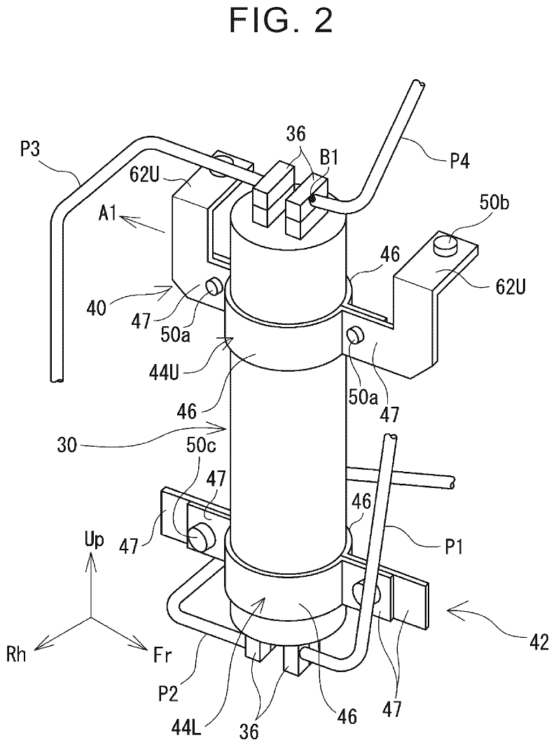

In the following description, of the plurality of pipes connected to the accumulator 30, the pipe connecting the accumulator 30 and the compressor 16 is referred to as a “first pipe P1”, and the pipe connecting the gas cooler 18 and the accumulator 30 is referred to as a “second pipe P2”. Further, a pipe connecting the accumulator 30 and the cooling expansion valve 26 is referred to as a “third pipe P3”, and a pipe connecting the evaporator 27 and the accumulator 30 is referred to as a “fourth pipe P4”. As illustrated in FIG. 2, which will be described later, the first pipe P1 and the second pipe P2 are connected to the lower portion of the accumulator 30, and the third pipe P3 and the fourth pipe P4 are connected to the upper portion of the accumulator 30.

The cooling expansion valve 26 is a solenoid valve that is throttle-controlled during a cooling operation and is completely closed during a heating operation. When the cooling expansion valve 26 is throttled, CO₂ refrigerant is rapidly reduced in pressure when passing through the cooling expansion valve 26. The evaporator 27 is an evaporator for evaporating the liquid CO₂ refrigerant, and is disposed in a flow path of the air-conditioned air provided in the unit case 70. The latent heat generated during the evaporation cools the air around the evaporator 27.

Although not shown in FIG. 1, the refrigerant circuit 12 is provided with some solenoid valves for switching the direction in which the air-conditioning refrigerant flows. Further, the refrigerant circuit 12, a plurality of PT sensors 28 for detecting the pressure and temperature of CO₂ refrigerant flowing through the refrigerant pipe 14 are arranged.

A blowing mechanism 72 is disposed in the vehicle cabin. The blowing mechanism 72 is a mechanism that cools or heats air taken in from the outside or the inside of the vehicle and blows the air into the vehicle. The blowing mechanism 72 includes a unit case 70, a blower fan 20, and a heater core 22. The downstream end of the unit case 70, the air outlet (not shown) for guiding the air conditioning air into the vehicle is formed. Further, an evaporator 27 and a heater core 22 are disposed in the unit case 70. During the cooling operation, the evaporator 27 cools the air sent from the blower fan 20 by the latent heat when the air-conditioning refrigerant is vaporized. The cooled air-conditioned air is output to the inside of the vehicle, thereby cooling the inside of the vehicle.

The heater core 22 is heated by another heat source during the heating operation. The other heat source may be, for example, an engine or an electric heater. The heater core 22 is directly heated by another heat source. Alternatively, the heater core 22 is indirectly heated via a refrigerant such as water. A mode switching door 24 is disposed upstream of the heater core 22. The mode switching door 24 adjusts the amount of air passing through the heater core 22. During the heating operation, the mode switching door 24 moves to a position where the wind toward the heater core 22 is not blocked (a position indicated by a broken line in FIG. 1). As a result, the air sent from the blower fan 20 passes through the heater core 22 and is heated. The heated air-conditioning air is output to the inside of the vehicle, thereby heating the inside of the vehicle cabin.

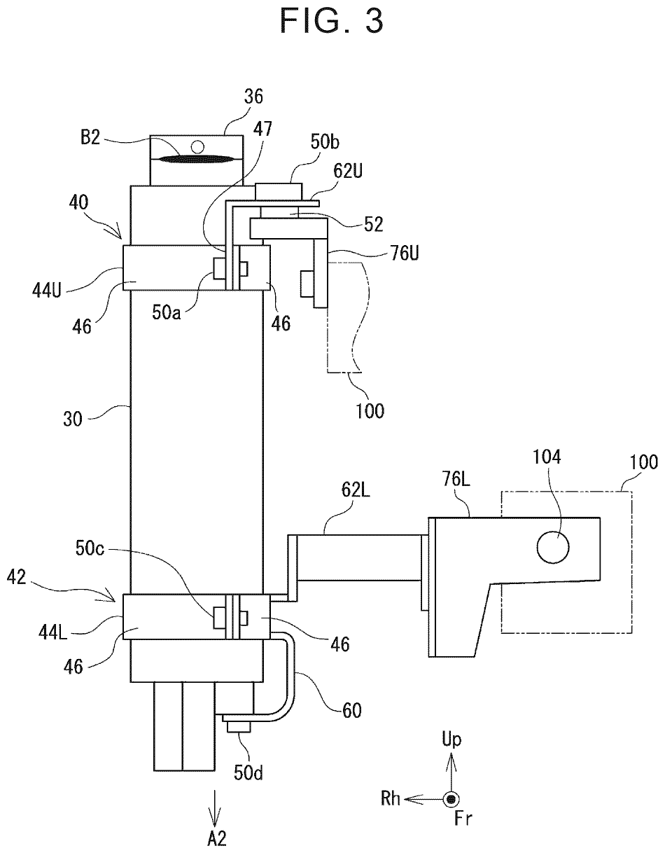

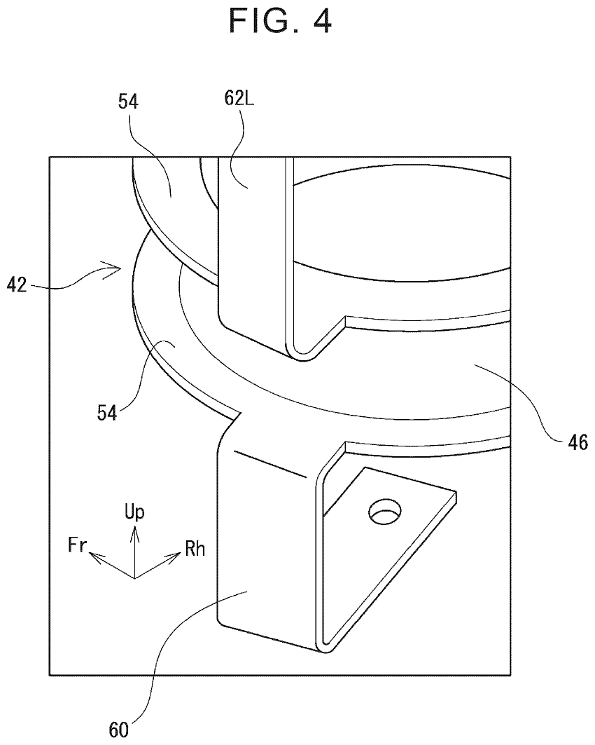

Since the operation of the air conditioner 10 is known, a detailed description thereof will be omitted. Note that the configuration of the air conditioner 10 shown in FIG. 1 is an example, and may be changed as appropriate. Next, the mounting structure of the accumulator 30 will be described with reference to FIGS. 2 to 4. FIG. 2 is a perspective view of the periphery of the accumulator 30. FIG. 3 is a side view of the periphery of the accumulator 30, and FIG. 4 is an enlarged view of a main part of the lower bracket 42. In FIGS. 2 to 4, Fr, Up, and Rh indicate the front, upper, and right sides of the vehicle, respectively.

As described above, CO₂ refrigerant has a higher pressure than the fluorine-based refrigerant. When the accumulator 30 or the refrigerant pipe 14 around the accumulator is damaged due to a collision or the like of the vehicles, the high-pressure CO₂ refrigerant is ejected. The propulsive force generated by this jetting may cause the accumulator 30 to “fire” vigorously, like a rocket. In the present example, the movement of the accumulator 30 is constrained by the brackets 40, 42 in order to prevent or reduce such “firing” of the accumulator 30. Hereinafter, this will be described in detail.

The accumulator 30 is disposed, for example, in a power unit room in a front portion of the vehicle. The power unit compartment is a space in which a power source (for example, an engine or a motor or both) of a vehicle is disposed. In addition to the power source, a part of the air conditioner 10 (for example, the gas cooler 18 and the compressor 16) is usually arranged in the power unit chamber. The accumulator 30 is disposed in the power unit chamber and is attached to a fixing member 100 such as a vehicle body via brackets 40, 42 described later.

As shown in FIGS. 2 and 3, the accumulator 30 is substantially in a cylindrical shape elongated in the up-down direction. The body 32 and the heat exchanger 34 are housed inside the cylindrical casing. Two connectors 36 are provided on the upper surface of the accumulator 30. A third pipe P3 and a fourth pipe P4 are connected to each of the two connectors 36. The third pipe P3 and the fourth pipe P4 extend horizontally from the connector 36 and are then bent in the up-down direction.

Two connectors 36 are also provided on the bottom surface of the accumulator 30. A first pipe P1 and a second pipe P2 are connected to each of the two connectors 36. The first pipe P1 extends horizontally and then bends upward. The second pipe P2 travels horizontally while being bent a few times from the connector 36, and is connected to the lower portion of the gas cooler 18.

Further, an upper bracket 40 and a lower bracket 42 are attached to the accumulator 30. Each of the upper bracket 40 and the lower bracket 42 is a metal fitting for connecting the accumulator 30 to the fixing member 100 (see FIG. 3). The upper bracket 40 is configured by combining an annular bracket 44U surrounding the outer periphery of the accumulator 30 and a mounting portion 62U. The annular bracket 44U sandwiches the body of the accumulator 30 with two half rings 46. Each half ring 46 has a flat plate portion 47 extending radially outward from a circumferential end portion thereof. The flat plate portions 47 of the two half rings 46 are stacked in the thickness direction and fastened with a bolt 50a. Note that, although illustrated in FIGS. 2 and 3 in a simplified manner, the half ring 46 actually has flanges 54 extending radially outward at its upper and lower ends, similar to the lower annular bracket 44L shown in FIG. 4. By providing the flange 54 in this manner, the cross-sectional coefficient of the half ring 46 is improved, and the rigidity of the half ring 46 is improved.

Further, as shown in FIGS. 2 and 3, a portion of the flat plate portion 47 is further extended to form a mounting portion 62U that is directly or indirectly attached to the fixing member 100. In the exemplary embodiments of FIGS. 2 and 3, the mounting portion 62U is substantially in an L-shape, and extends upward from the flat plate portion 47 and then bends horizontally. The distal end of the mounting portion 62U is fastened to the intermediate bracket 76U with a bolt 50b. A rubber-mount 52 is disposed between the mounting portion 62U and the intermediate bracket 76U. The rubber mount 52 absorbs vibrations generated in the accumulator 30 and the vehicle. The intermediate bracket 76U is fastened to a fixing member 100 such as a vehicle body. Note that the mounting portion 62U may be directly fastened to the fixing member 100 without using the intermediate bracket 76U.

A lower bracket 42 is attached to a lower portion of the accumulator 30. The lower bracket 42 is roughly divided into an annular bracket 44L, a shaft-side bracket 60, and a mounting portion 62L. In FIG. 2, the shaft-side bracket 60 and the mounting portion 62L are hidden from the accumulator 30.

The annular bracket 44L has substantially the same configuration as the annular bracket 44U of the upper bracket 40. That is, the annular bracket 44L has two half rings 46 sandwiching the accumulator 30, and the two half rings 46 are fastened with a bolt 50c. As shown in FIG. 4, each half ring 46 has a flange 54 extending radially outward from its upper and lower ends.

A mounting portion 62L is connected to a flange 54 extending from the upper end of the half ring 46, and a shaft-side bracket 60 is connected to a flange 54 extending from the lower end. The mounting portion 62L extends from the annular bracket 44L and is coupled to the fixing member 100 either directly or indirectly via the intermediate bracket 76L, as shown in FIG. 3. Further, although not visible in FIG. 3, a rubber mount is disposed in the fastening portion 104 between the intermediate bracket 76L and the fixing member 100, and the vibration is absorbed by the rubber mount.

As shown in FIGS. 3 and 4, the shaft-side bracket 60 extends radially outward from the half ring 46, then advances downward, and then turns U to extend radially inward. Thus, the shaft-side bracket 60 is substantially in an angular U-shape. The distal end of the shaft-side bracket 60 is placed on the axial end face of the accumulator 30 and coupled to the accumulator 30 with a bolt 50d.

As is obvious from the above explanation, in the present embodiment, the annular brackets 44U, 44L and the shaft-side bracket 60 are attached to the accumulator 30. This makes it possible to more reliably prevent or reduce unintentional movement of the accumulator 30. That is, as described above, when the accumulator 30 or the refrigerant pipe 14 in the vicinity thereof is damaged due to a collision or the like of the vehicle, a strong gas ejection pressure acts on the accumulator 30. This gas ejection pressure could unintentionally “fire” the accumulator 30 vigorously like a rocket.

For example, a case where the fourth pipe P4 falls off from the connector 36 in the position B1 of FIG. 2 will be considered. Here, since the high-pressure CO₂ refrigerant is ejected radially from the damaged portion, the accumulator 30 may be vigorously “fired” in the radial direction (i.e., in the direction of the arrow A1 in FIG. 2). However, in the present embodiment, annular brackets 44U, 44L are mounted around the accumulator 30. The annular brackets 44U, 44L each have a surface facing the accumulator 30 in the radial direction (i.e., the firing direction). Therefore, even if the accumulator 30 attempts to move radially, the movements thereof are restricted by the annular brackets 44U, 44L. As a result, radial “firing” of the accumulator 30 is prevented.

Further, it is assumed that the connector 36 itself is detached from the accumulator 30 in the position B2 of FIG. 3. In this case, the shaft-side bracket 60 is not provided, and only the annular brackets 44U, 44L are considered. In this instance, the accumulator 30 may exit the annular brackets 44U, 44L and be vigorously “fired” in the axial direction (i.e., in the direction of the arrow A2 in FIG. 3). On the other hand, in the present example, the shaft-side bracket 60 is attached to the axial end face of the accumulator 30. The shaft-side bracket 60 has a surface facing the accumulator 30 in the axial direction (i.e., the firing direction). Therefore, even if the accumulator 30 attempts to move in the axial direction, the movement thereof is restricted by the shaft-side bracket 60. As a result, axial “firing” of the accumulator 30 is prevented.

As described above, in the present embodiment, by providing both the annular brackets 44U, 44L and the shaft-side bracket 60, the radial and axial movements of the accumulator 30 are restricted, and unintentional “firing” of the accumulator 30 can be effectively prevented or reduced. In addition, the accumulator 30 is generally elongated in the axial direction and has a shape that is easily collapsed. By attaching a plurality of (two in this embodiment) annular brackets 44U, 44L axially spaced apart to such an accumulator 30, tilting of the accumulator 30 is effectively prevented. In this embodiment, the shaft-side bracket 60 is integral with the annular bracket 44L of the lower bracket 42. Thus, it is not necessary to extend the shaft-side bracket 60 to the fixing member 100, and the shaft-side bracket 60 can be miniaturized.

Note that the configuration described so far is an example. For example, in the above explanation, the shaft-side bracket 60 is integral with the lower annular bracket 44L, but they may be separate members that are completely separated from each other. In this case, the shaft-side bracket 60 may also be provided with a mounting portion that is directly or indirectly connected to the fixing member 100. In the above description, the shaft-side bracket 60 is connected to the bottom surface of the accumulator 30, but the shaft-side bracket 60 may be connected to the top surface. The shapes and the numbers of shaft-side brackets 60 and annular brackets 44U, 44L may also be changed as appropriate. In addition, although the accumulator 30 of the present example incorporates the heat exchanger 34, the mounting structure disclosed herein may be applied to the accumulator 30 that does not have the heat exchanger 34.

What is claimed is:

1. A mounting structure for an accumulator, the mounting structure comprising:
an accumulator incorporated in an in-vehicle air conditioner, the accumulator being configured to separate a refrigerant mainly containing CO₂ into a gaseous refrigerant and a liquid refrigerant; and
two or more brackets that mount the accumulator to a fixing member,
wherein the two or more brackets include
an annular bracket that surrounds the accumulator in a circumferential direction, and
a shaft-side bracket, at least part of the shaft-side bracket being placed on and coupled to an axial end face of the accumulator.

2. The mounting structure according to claim 1, wherein two of the annular brackets are provided spaced apart in an axial direction of the accumulator.

3. The mounting structure according to claim 1, wherein one end of the shaft-side bracket is coupled to the axial end face of the accumulator, and another end of the shaft-side bracket is integrally connected to the annular bracket.

4. A mounting structure for an accumulator, the mounting structure comprising:
an accumulator incorporated in an in-vehicle air conditioner, the accumulator being configured to separate a refrigerant mainly containing CO₂ into a gaseous refrigerant and a liquid refrigerant; and
one or more brackets that mount the accumulator to a fixing member,
wherein the one or more brackets hold the accumulator so as to restrict movement of the accumulator due to gas ejection that occurs when the accumulator or a refrigerant pipe near the accumulator is damaged.

5. The mounting structure according to claim 4, wherein the one or more brackets have a surface that faces the accumulator in a direction of the gas ejection.
